(19) United States
(12) Patent Application Publication
(10) Pub. No.: US 2009/0084193 A1
(43) Pub. Date: Apr. 2, 2009

(54) Apparatus for measuring an exhaust gas recirculation flow of an internal combustion engine

(76) Inventors: Victor Cerabone, Waterford, MI (US); Harald Gieb, Weinstadt (DE)

Correspondence Address: KLAUS J. BACH, 4407 TWIN OAKS DRIVE, MURRYSVILLE, PA, 15668, US

(21) Appl. No.: 11/904,619

(22) Filed: Sep. 27, 2007

(51) Int. Cl. G01F 1/44

(52) U.S. Cl. 73/861.64; 73/861.52

(57) ABSTRACT

In an apparatus for measuring an exhaust gas recirculation flow through an exhaust gas recirculation line of an internal combustion engine, the exhaust gas recirculation line has a constriction region and a flange structure integrally formed therewith, said communication line extending from the constriction region to the flange structure on which a differential pressure sensor is disposed and being formed into the wall of the exhaust gas recirculation line so as to be in communication with the differential pressure sensor mounted on the flange structure for determining the exhaust gas flow through the recirculation line.

### BACKGROUND OF THE INVENTION

The invention relates to an apparatus for measuring a mass flow of an exhaust gas recirculation system of an internal combustion engine, which apparatus comprises an exhaust gas recirculation line which has a constriction and which includes a first communication line and a second communication line which are connected in each case to the exhaust gas recirculation line with a pressure sensor being connected to the communication lines. At least the first communication line is connected to the exhaust gas recirculation line in the constriction region.

U.S. Pat. No. 6,347,519 B1 discloses an apparatus for measuring a mass flow of an exhaust gas recirculation system of a compression ignition engine having an exhaust gas turbocharger with a turbine including a variable turbine geometry. The exhaust gas recirculation line includes a constriction, and a differential pressure sensor detects a differential pressure using the pressure of the recirculated exhaust gas flow in front of the constriction and the pressure of the recirculated exhaust gas after the constriction. A throttle element is disposed in the exhaust gas recirculation line for controlling the constriction.

It is the object of the invention to provide an apparatus for measuring a mass flow of an exhaust gas recirculation system, which apparatus can be used for a multiplicity of internal combustion engines and for which assembly times and costs are reduced.

### SUMMARY OF THE INVENTION

In an apparatus for measuring an exhaust gas recirculation flow through an exhaust gas recirculation line of an internal combustion engine, the exhaust gas recirculation line has a constriction region and a flange structure integrally formed therewith, said communication line extending from the constriction region to the flange structure on which a differential pressure sensor is disposed and being formed into the wall of the exhaust gas recirculation line so as to be in communication with the differential pressure sensor mounted on the flange structure for determining the exhaust gas flow through the recirculation line.

A second communication line may be provided which extends from an area of the exhaust gas recirculation line spaced from the constriction region to the differential pressure sensor. The pressure differential is established according to what is known as the Venturi principle. The differential pressure sensor detects the difference in the pressures in the communication lines. Advantageously, both communication lines are integrated into the exhaust gas recirculation line.

Additional throttle elements are not needed with the configuration of the exhaust gas recirculation line in which a constriction is formed, for example, by a line cross section diminishing in axial direction and a resulting diminishing flow cross section. For optimum utilization of the installation space, in particular in an engine compartment, the communication lines for differential pressure measurement are integrated into the exhaust gas recirculation line. At least one communication line is integrated into the wall of the exhaust gas recirculation line in the constriction region, a simple flange connection being configured, in particular formed, at the same time for accommodating a pressure sensor on the outer wall of the exhaust gas recirculation line. This reduces the costs with regard to the assembly, as no installation of external lines is necessary. Furthermore, the assembly time is reduced on account of this design. The exhaust gas recirculation line is preferably incorporated as a component and shaped part, for example as a cast part.

Exemplary embodiments of the invention will be described below in greater detail on the basis of the accompanying drawings:

### BRIEF DESCRIPTION OF THE DRAWINGS

FIG. 1 diagrammatically shows a perspective illustration, an exhaust gas recirculation line having communication lines which are integrated into a wall in a constriction region of the flow cross section for differential pressure measurements,

FIG. 2 diagrammatically shows the exhaust gas recirculation line in the constriction region with integrated communication lines, in a longitudinal cross-sectional view,

FIG. 3 diagrammatically shows a plan view of a connecting point of the exhaust gas recirculation line,

FIG. 4 is a diagrammatic plan view of a connecting flange for connecting a differential pressure sensor,

FIG. 5 is a diagrammatic diagonal sectional view of the connecting flange for a differential pressure sensor with integrated communication lines and

FIG. 6 shows, in a diagrammatic diagonal sectional view, the connecting flange for a differential pressure sensor with integrated communication lines.

### DESCRIPTION OF ADVANTAGEOUS EMBODIMENT

Parts which correspond to one another are provided with the same designations or reference numerals in all the figures.

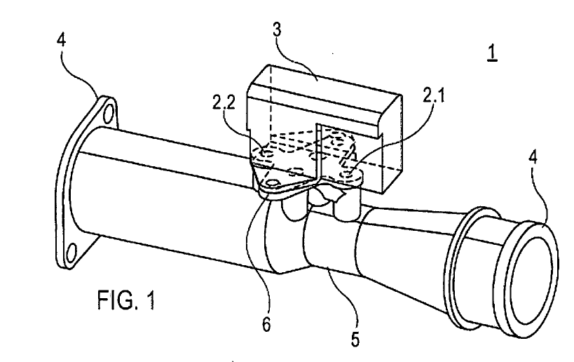

FIG. 1 diagrammatically shows a perspective view of an exhaust gas recirculation line 1 having integrated communication lines 2.1, 2.2 for differential pressure measurement. A differential pressure sensor 3 which detects the mass flow in the exhaust gas recirculation system on the basis of a differential pressure can be connected to the communication lines 2.1, 2.2.

The exhaust gas recirculation line 1 can be configured such that it is divided into a plurality of pipe elements. Here, connecting points 4, for example flanges and screw or plug-in connections, are formed at the respective pipe end for further pipe elements of the exhaust gas recirculation system. Moreover, the exhaust gas recirculation line 1 is held or fastened in a form-fitting and force-transmitting manner on a component, for example on the engine housing or chassis, via a holding device which is not shown.

The exhaust gas recirculation line 1 includes a constriction region 5, for example as a result of the provision of two conical sections which are oriented counter to one another. As a result, a section of the exhaust gas recirculation line 1 itself is configured as what is known as a Venturi pipe. Into this line section, a differential pressure measurement arrangement can be integrated in a simple way. To this end, a first communication line 2.1 is connected to the exhaust gas recirculation line in the region of the smallest flow cross section of the constriction region 5 and a second communication line 2.2 is connected in the direction of flow in front of the constriction region 5.

In order to integrate the communication lines 2.1, 2.2 into the exhaust gas recirculation line 1, the latter has an increasing wall thickness in the constriction region 5, into which increasing wall thickness at least one or both communication lines 2.1, 2.2 are integrated and which is additionally configured as a connecting flange 6. The differential pressure sensor 3 can be connected, in particular flange-connected, in a form-fitting and force-transmitting manner to the connecting flange 6 in a simple way.

Here, the connecting flange 6 has a surface structure which ensures heat dissipation. For example, the surface structure is in the form of cooling fins 7. In one possible embodiment, the connecting flange 6 is formed from aluminum for good heat dissipation.

The exhaust gas recirculation line 1 with the constriction region 5 and the connecting flange 6 is preferably configured as one component, in particular an extruded or cast shaped part. The component can therefore be produced in a simple manner and is inexpensive. Also, no additional throttle elements are needed.

The differential pressure sensor 3 which is connected to the communication lines 2.1, 2.2 measures the differential pressure of the exhaust gas which is recirculated in the exhaust gas recirculation line 1 according to what is known as the Venturi principle. The recirculated exhaust gas flows through the exhaust gas recirculation line 1 which includes integrated therein the communication lines 2.1, 2.2. Before the constriction region 5 is reached, a dynamic pressure (back pressure) of the exhaust gas is low and a static pressure (rest pressure) is comparatively high. When the recirculated exhaust gas flows through the constriction region 5, the pressure which prevails in the exhaust gas changes (according to Bernoulli's law). The dynamic pressure is at a maximum and the static pressure is at a minimum at the narrowest point of the exhaust gas recirculation line 1. The velocity of the flowing exhaust gas rises in accordance with the reduced flow cross section when the flow passes through the constriction region 5. At the same time, the pressure drops in the communication line 2.1 which extends from the constriction region 5 in the region of the smallest flow cross section. A vacuum is produced which is detected by the differential pressure sensor 3. In one exemplary embodiment, depending on the vacuum which prevails, fresh air is fed to the recirculated exhaust gas, that is, the fresh air is sucked in.

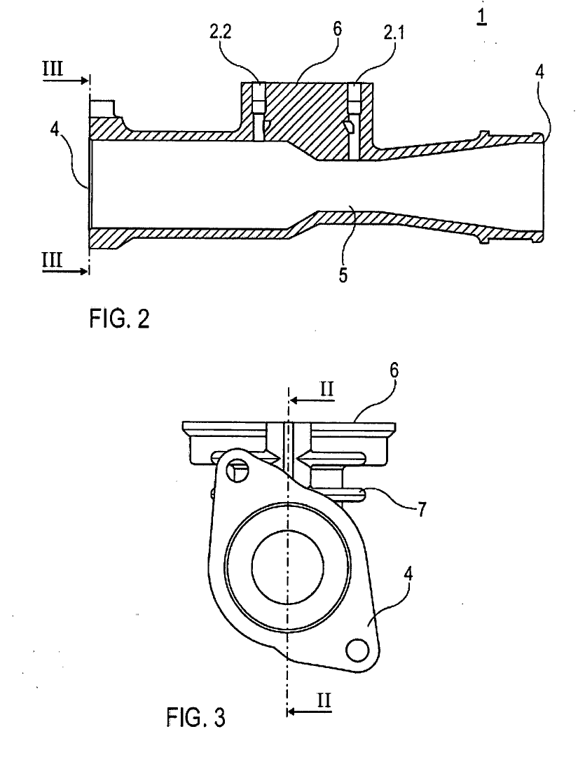

FIG. 2 diagrammatically shows an illustration of the exhaust gas recirculation line 1 in longitudinal sectional view.

Here, at least one of the communication lines 2.1 which are integrated into the exhaust gas recirculation line 1 extends from the constriction region 5. The other communication line 2.2 is integrated into the wall of the exhaust gas recirculation line 1 in front of the constriction region 5, as viewed in the flow direction. The differential pressure sensor 3 is connected to the two communication lines 2.1 and 2.2 preferably measures the mass flow of the exhaust gas recirculation system.

FIG. 3 diagrammatically shows a plan view of a connecting point 4 of the exhaust gas recirculation line 1 showing also the cooling fins 7 which are integrated into the connecting flange 6.

The connecting point 4 is configured as a connecting flange for connecting a further pipe element of the exhaust gas recirculation line 1. Via the connecting flange, the pipe elements are connected to one another in a form-fitting and force-transmitting manner.

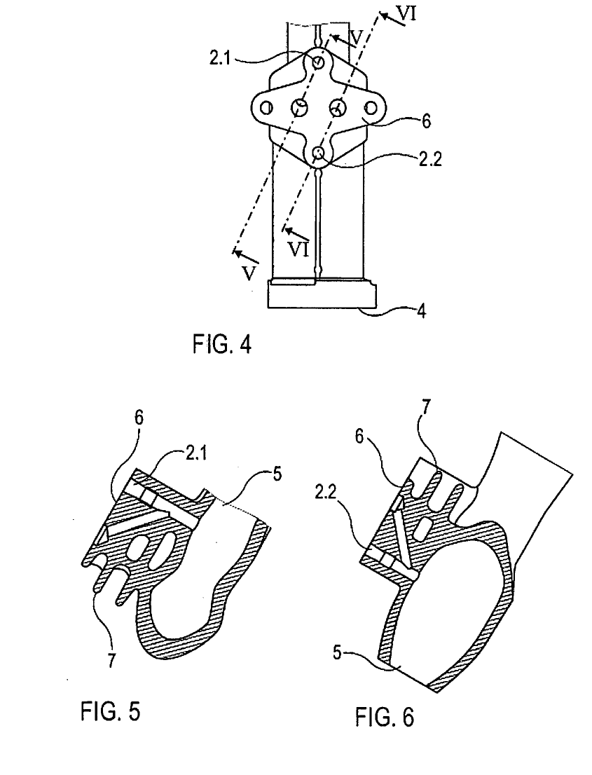

FIG. 4 diagrammatically shows a plan view of the connecting flange 6 of the differential pressure sensor 3. The differential pressure sensor 3 is connected to the connecting flange 6 in a form-fitting and force-transmitting manner by means of connecting elements, in particular screws. Here, the communication lines 2.1, 2.2 are integrated into the connecting flange 6. The differential pressure sensor 3 has a mating area which corresponds to the connecting flange 6 for fastening it to the connecting flange 6.

FIGS. 5 and 6 in each case show a diagonal section of the connecting flange 6 which is formed on the exhaust gas recirculation line 1 and has integrated communication lines 2.1, 2.2 for the differential pressure sensor 3. Here, the outer contour of the connecting flange 6 has a heat dissipating surface structure in the form of the cooling fins 7.

An inexpensive apparatus is therefore provided which is easy to assemble, saves installation space and permits the detection of a differential pressure of an exhaust gas recirculation system.

What is claimed is:

1. An apparatus for measuring an exhaust gas recirculation flow through an exhaust gas recirculation line (1) of an internal combustion engine, said exhaust gas recirculation line (1) including a constriction region (5), a first communication line (2.1)connected to the exhaust gas recirculation line (10 in the constriction region (5) thereof and a second communication line (2.2) connected to the exhaust gas recirculation line (1) spaced from the constriction region (5), a differential pressure sensor (3) connected to at least the first communication line (2.1) which is connected to the exhaust gas recirculation line (1) in the constriction region (5), the first communication line (2.1) being integrally formed in a wall section of the exhaust gas recirculation line (1), a flange structure being formed on the wall section and the differential pressure sensor being mounted onto the wall section in communication with the at least the first communication line 2.1.

2. The apparatus as claimed in claim 1, wherein also the second communication line (2.2) is integrally formed in the wall of the exhaust gas recirculation line (1) and connected to the differential pressure sensor (3).

3. The apparatus as claimed in claim 1, wherein the constriction region (5) is formed by an axially diminishing flow cross section of the exhaust gas recirculation line.

4. The apparatus as claimed in claim 1, wherein the second communication line (2.2) is connected to the exhaust gas recirculation line (1) in front of the constriction region (5), as viewed in the flow direction of the exhaust gas.

5. The apparatus as claimed in claim 1, wherein a connecting flange (6) which is provided for fastening the pressure sensor (3) has an outer surface configuration forming cooling fins (7).
